(19) United States
(12) Patent Application Publication
(10) Pub. No.: US 2025/0229640 A1
(43) Pub. Date: Jul. 17, 2025

(54) POWER CONTROL DEVICE

(71) Applicant: TOYOTA JIDOSHA KABUSHIKI KAISHA, Toyota-shi Aichi-ken (JP)

(72) Inventor: Yuki KURACHI, Okazaki-shi Aichi (JP)

(73) Assignee: TOYOTA JIDOSHA KABUSHIKI KAISHA, Toyota-shi Aichi-ken (JP)

(21) Appl. No.: 19/018,014

(22) Filed: Jan. 13, 2025

(30) Foreign Application Priority Data
Jan. 17, 2024 (JP) 2024-005591

(51) Int. Cl. B60L 15/00; H02J 1/08

(52) U.S. Cl. CPC B60L 15/007; H02J 1/08; B60L 2210/10

(57) ABSTRACT

A power control includes: an inverter for converting power from the high-voltage battery and outputting to the motor; a first DCDC converter for stepping down the power from the high-voltage battery and outputting to the auxiliary load; a second DCDC converter connected in parallel with the to the first DCDC converter; first and second power lines connecting positive and negative electrode terminals, respectively, of the high-voltage battery and the inverter; first and second relays in the first and second power lines, respectively; a smoothing capacitor, between the system main relay and the inverter, and connected to the first and second power lines; third and fourth relays, between the positive and negative electrode terminals, respectively, of the high-voltage battery and the second DCDC converter; and a fifth relay between a high-voltage end of the second DCDC converter and the smoothing capacitor.

### CROSS-REFERENCE TO RELATED APPLICATION(S)

The present application claims priority to and incorporates by reference the entire contents of Japanese Patent Application No. 2024-005591 filed in Japan on Jan. 17, 2024.

### BACKGROUND

The present disclosure relates to a power control device.

Japanese Laid-open Patent Publication No. 2021-145460 discloses that a power control device mounted on an electric vehicle pre-charges power from a high-voltage battery to the capacitor of the PCU through the DCDC converter while a system main relay state between the high-voltage battery and the PCU is turned off.

### SUMMARY

There is a need for providing a power control device capable of pre-charging a capacitor while suppressing the size enlargement of the body.

According to an embodiment, a power control device, mounted on an electric vehicle having no auxiliary battery, for supplying power of a high-voltage battery to a motor and an auxiliary load in the electric vehicle, includes: an inverter for converting the power from the high-voltage battery into AC power and outputting the AC power to the motor; a first DCDC converter, having a high voltage end connected to the high-voltage battery without passing through any relays and a low voltage end connected to the auxiliary load, for stepping down the power from the high-voltage battery and outputting the stepped-down power to the auxiliary load; a second DCDC converter, having a high voltage end connected to the high-voltage battery via relays and a low voltage end connected to the auxiliary, and connected in parallel with the to the first DCDC converter, and capable of bi-directional outputting to the sides of the high voltage end and the low voltage end; a first power line connecting a positive electrode terminal of the high-voltage battery and the inverter; a second power line connecting a negative electrode terminal of the high-voltage battery and the inverter; a system main relay including a first relay provided in the first power line, and a second relay provided in the second power line; a smoothing capacitor provided, provided between the system main relay and the inverter, and connected to the first power line and the second power line; an auxiliary relay including a third relay, provided between the positive electrode terminal of the high-voltage battery and the second DCDC converter, and a fourth relay, provided between the negative electrode terminal of the high-voltage battery and the second DCDC converter; and a pre-charge relay, which is a fifth relay provided between a high-voltage end of the second DCDC converter and the smoothing capacitor.

### BRIEF DESCRIPTION OF THE DRAWINGS

FIG. 1 is a schematic diagram illustrating a power control device according to an embodiment;

FIG. 2 is a diagram for explaining a case in which an ignition of an electric vehicle is in an off state;

FIG. 3 is a diagram for explaining a time of pre-charging; and

FIG. 4 is a diagram for explaining a traveling time of the electric vehicle.

### DETAILED DESCRIPTION

In the configuration described in Japanese Laid-open Patent Publication No. 2021-145460, three relays and one resistor are required between the high-voltage battery and DCDC converter, and two relays are required between the DCDC converter and the capacitor of the PCU. Since the configuration described in Japanese Laid-open Patent Publication No. 2021-145460 requires a total of seven relays including two relays of the system main relay, and thus, there is a possibility that the body size is increased.

Hereinafter, the power control device in the embodiment of the present disclosure will be specifically described. Note that the present disclosure is not limited to the embodiments described below.

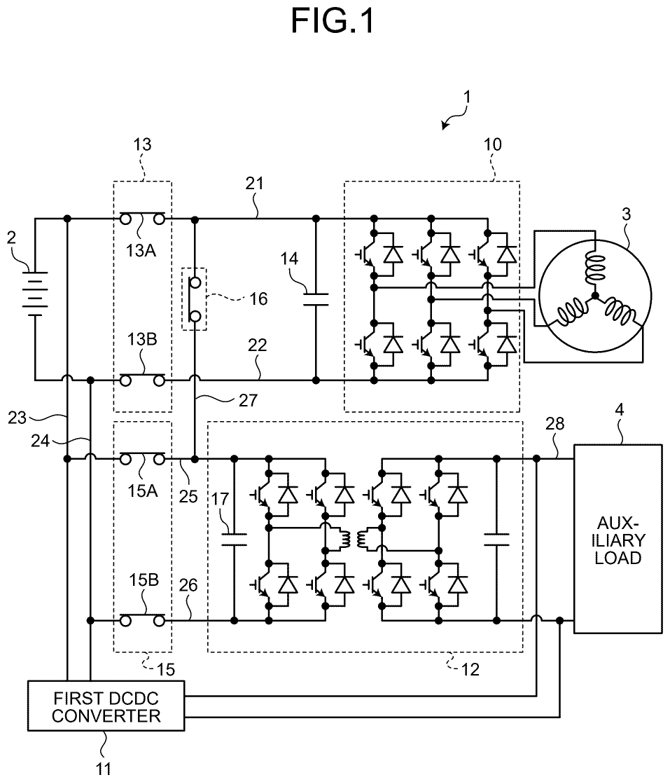

FIG. 1 is a schematic diagram illustrating a power control device according to an embodiment. A power control device 1 is mounted on an electric vehicle without an auxiliary battery. The power control device 1 supplies power of the high-voltage battery 2 in the electric vehicle to a motor 3 and an auxiliary load 4. The high-voltage battery 2 is a battery to be mounted on an electric vehicle. The high-voltage battery 2 is composed of a secondary battery such as a lithium-ion battery. The high-voltage battery 2 supplies power to the motor 3 and the auxiliary load 4. The motor 3 is a driving motor which functions as a power source of the electric vehicle. The motor 3 is driven by electric power supplied from the high-voltage battery 2. The auxiliary load 4 is an auxiliary component mounted on the electric vehicle. Electric power from the high-voltage battery 2 is stepped down and supplied to the auxiliary load 4.

The power control device 1 includes an inverter 10, a first DCDC converter 11, a second DCDC converter 12, a system main relay (hereinafter may be simplified as SMR) 13, a smoothing capacitor 14, an auxiliary relay 15, and a pre-charge relay 16.

The inverter 10 is a power conversion device provided between the high-voltage battery 2 and the motor 3. The inverter 10 is connected to the high-voltage battery 2 through a relay. The inverter 10 converts the DC power from the high-voltage battery 2 into AC power and outputs it to the motor 3. The inverter 10 is connected to the high-voltage battery 2 via the SMR 13.

The first DCDC converter 11 is a power converter provided between the high-voltage battery 2 and the auxiliary load 4. The first DCDC converter 11 is constituted by an isolated DCDC converter. The first DCDC converter 11 steps down the voltage of the DC power from the high-voltage battery 2 and outputs it to the auxiliary load 4. The first DCDC converter 11 are connected to the high-voltage battery 2 without using relays.

The second DCDC converter 12 is a power converter connected in parallel with 1DCDC converter 11 between the high-voltage battery 2 and the auxiliary load 4. The second DCDC converter 12 is a bidirectional DCDC converter capable of outputting in both directions of the high voltage end and the low voltage end. The second DCDC converter 12 is constituted by an isolated DCDC converter. The second DCDC converter 12 has a capacitor 17 provided on the high voltage end side, and a capacitor provided on the low voltage end side. The second DCDC converter 12 are connected to the high-voltage battery 2 via relays.

The power control device 1 includes a first power line 21 that connects the positive electrode terminal of the high-voltage battery 2 and the inverter 10, and a second power line 22 that connects the negative electrode terminal of the high-voltage battery 2 and the inverter 10.

The first power line 21 is a positive power line. The second power line 22 is the negative side power line.

The SMR 13 is a relay provided between the high-voltage battery 2 and the inverters 10. The SMR 13 includes a first relay 13A provided in the first power line 21, and a second relay 13B provided in the second power line 22. When the first relay 13A and the second relay 13B are turned on, the high-voltage battery 2 and the inverter 10 are electrically connected to each other. When the first relay 13A and the second relay 13B is turned off, the space between the high-voltage battery 2 and the inverter 10 is cut off so as not to be energized. The SMR 13 switches between on-state and off-state in response to a command signal from an electronic controller. When the first relay 13A and the second relay 13B are not particularly distinguished from each other, the relay is referred to as the SMR 13.

The smoothing capacitor 14 is a capacitor provided between the SMR 13 and the inverter 10. The smoothing capacitor 14 is connected to the first power line 21 and the second power line 22. One end of the smoothing capacitor 14 is connected to a portion between the first relay 13A and the inverter 10 in the first power line 21. The other end of the smoothing capacitor 14 is connected to the portion between the second relay 13B and the inverter 10 in the second power line 22.

The power control device 1 includes a third power line 23 that connects the positive electrode terminal of the high-voltage battery 2 and the first DCDC converter 11, and a fourth power line 24 that connects the negative electrode terminal of the high-voltage battery 2 and the first DCDC converter 11. The third power line 23 is a power line of the high voltage system connecting the first power line 21 and the first DCDC converter 11. The third power line 23 has one end connected to a portion between the positive electrode terminal of the high-voltage battery 2 and the first relay 13A in the first power line 21 and the other end connected to the high-voltage end of the first DCDC converter 11. The fourth power line 24 is a power line of a high voltage system connecting the second power line 22 and the first DCDC converter 11. The fourth power line 24 has one end connected to a portion between the negative electrode terminal of the high-voltage battery 2 and the second relay 13B in the second power line 22 and the other end connected to the high-voltage end of the first DCDC converter 11.

The power control device 1 includes a fifth power line 25 that connects the positive electrode terminal of the high-voltage battery 2 and the second DCDC converter 12, and a sixth power line 26 that connects the negative electrode terminal of the high-voltage battery 2 and the second DCDC converter 12. The fifth power line 25 is a power line of the high voltage system connecting the third power line 23 and the second DCDC converter 12. The fifth power line 25 has one end connected to the third power line 23 and the other end connected to the high-voltage end of the second DCDC converter 12. The sixth power line 26 is a power line of the high voltage system connecting the fourth power line 24 and the second DCDC converter 12. The sixth power line 26 has one end connected to the fourth power line 24 and the other end connected to the high-voltage end of the second DCDC converter 12.

The auxiliary relay 15 is a relay provided between the high-voltage battery 2 and the second DCDC converter 12. The auxiliary relay 15 includes a third relay 15A provided in the fifth power line 25, and a fourth relay 15B provided in the sixth power line 26. The third relay 15A is a relay that cuts off or connects the power path between the positive electrode terminal of the high-voltage battery 2 and the high-voltage end of the second DCDC converter 12. The fourth relay 15B is a relay that cuts off or connects the power path between the negative electrode terminal of the high-voltage battery 2 and the high-voltage end of the second DCDC converter 12.

When the third relay 15A and the fourth relay 15B are turned on, the high-voltage end of the high-voltage battery 2 and the second DCDC converter 12 are electrically connected to each other through the auxiliary relay 15. When the auxiliary relay 15 is in the ON state, the first the second DCDC converter 12 functions as a step-down converter, and the power from the high-voltage battery 2 is stepped down and outputted to the auxiliary equipment load 4. When the third relay 15A and the fourth relay 15B are turned off, the high-voltage end of the high-voltage battery 2 and the second DCDC converter 12 are cut off. The accessory relay 15 switches between an on-state and an off-state in response to a command signal from an electronic controller. Incidentally, when not particularly distinguished from the third relay 15A and the fourth relay 15B is described as auxiliary relay 15.

The power control device 1 includes a seventh power line 27 connecting the second DCDC converter 12 and the smoothing capacitor 14. The seventh power line 27 is a power line for connecting the first power line 21 and the fifth power line 25. The seventh power line 27 has one end connected to a portion between the first relay 13A and the smoothing capacitor 14 in the first power line 21 and the other end connected to a portion between the third relay 15A and the second DCDC converter 12 in the fifth power line 25.

The pre-charge relay 16 is a relay provided between the second DCDC converter 12 and the smoothing capacitor 14. The pre-charge relay 16 is a fifth relay provided in the seventh power line 27. The pre-charge relay 16 is constituted by only one relay. The pre-charge relay 16 includes only the fifth relay provided between one of the high-voltage ends of the second DCDC converter 12 and one end of the smoothing capacitor 14. The pre-charge relay 16 is a relay that cuts off or connects the power path between the high-voltage end of the second DCDC converter 12 and smoothing capacitor 14.

When the pre-charge relay 16 is turned on, the capacitor 17 and the smoothing capacitor 14 at the high-voltage end of the first the second DCDC converter 12 are electrically connected to each other. When the pre-charge relay 16 is on, the first the second DCDC converter 12 functions as a boost converter, by boosting from a low voltage to a high voltage, it is possible to pre-charge the capacitor 17 of the auxiliary relay 15 at the same time the pre-state of the smoothing capacitor 14.

The first DCDC converter 11 are electrically connected between the third power lines 23 and the low-voltage lines 28 of the high-voltage system. The first DCDC converter 11 supplies the voltage of the third power line 23 to the low voltage line 28 by stepping down. The first DCDC converter 11 is electrically connected to the auxiliary loads 4 and the second DCDC converter 12 via the low-voltage line 28. The low voltage end of the low voltage end and the second DCDC converter 12 of the first DCDC converter 11 is connected via the low voltage line 28.

The second DCDC converter 12 are electrically connected between the fifth power line 25 and the low-voltage line 28 of the high-voltage system. The second DCDC converter 12 is electrically connected to the auxiliary loads 4 and the first DCDC converter 11 via the low-voltage line 28.

When the accessory relay 15 is on, the second DCDC converter 12 can function as a buck converter. When functioning as a step-down converter, the second DCDC converter 12 supplies the voltage of the fifth power line 25 to the low voltage line 28. When the auxiliary relay 15 is in the off-state, the second DCDC converter 12 functions as a boost converter. When functioning as a boost converter, the second DCDC converter 12 boosts the voltage of the low voltage line 28 is supplied to the fifth power line 25.

In the power control device 1 configured in this way, a total of five relays including two relays of the SMR 13, two relays of the auxiliary relay 15, and one relay of the pre-charge relay 16 are provided. The power controller 1 is applied to systems without auxiliary batteries, and the first DCDC converter 11 constantly power the low voltage system components instead of the auxiliary batteries. The inverter 10 and the second DCDC converter 12 are connected to the high-voltage battery 2 via relays, respectively. By providing one pre-state relay 16 between the capacitor 17 of the smoothing capacitor 14 and the second DCDC converter 12, it is possible to pre-charge the smoothing capacitor 14 with a relay in both poles of the high-voltage battery 2.

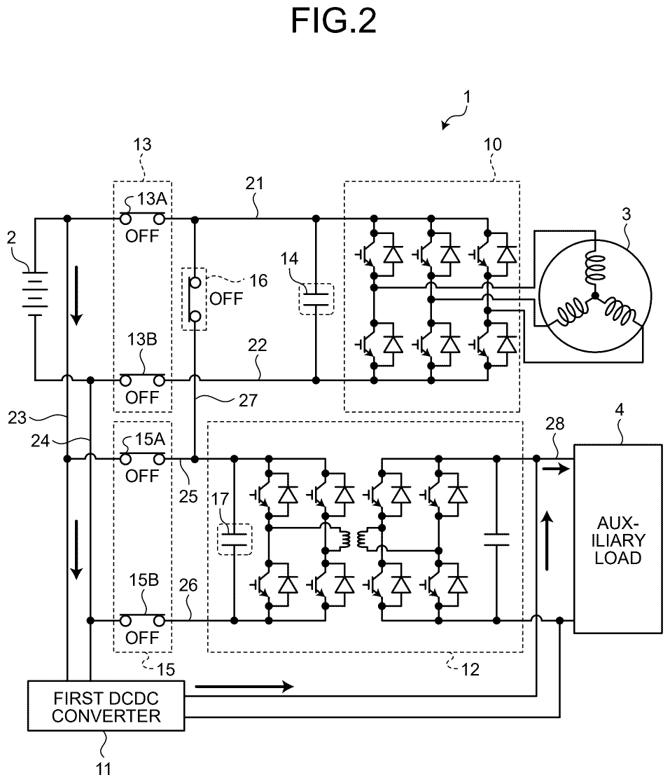

FIG. 2 is a diagram for explaining a case in which the ignition of the electric vehicle is in the off state. When the ignition of the electric vehicle is in the off-state, the power control device 1 lowers the voltage of the high-voltage battery 2 to a low voltage by the first DCDC converter 11 to provide the standby power of the auxiliary load 4. In this instance, the SMR 13, the auxiliary relay 15, and the pre-charge relay 16 are all turned off. The SMR 13 and the auxiliary relay 15 and the pre-charge relay 16 are constituted by normally open relays.

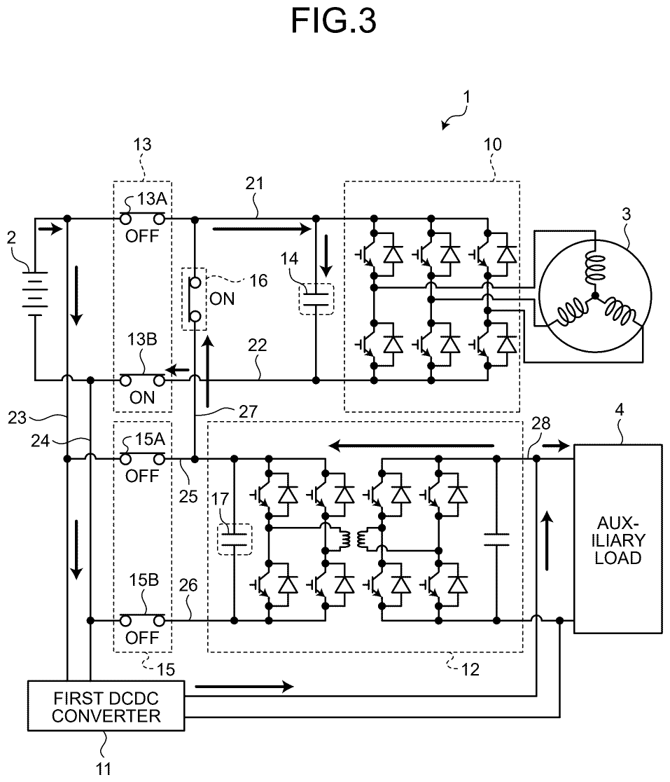

FIG. 3 is a diagram for explaining the time of pre-charge. When the ignition of the electric vehicle is switched from the off state to the on state, the power control device 1 performs pre-charging of the smoothing capacitor 14. When the electric vehicle is started, the power control device 1 switches the second relay 13B and the pre-charge relay 16 from the off state to the on state as the first operation. When the second relay 13B and the pre-state relay 16 are turned on, a power path is formed from the high-voltage battery 2 through the first DCDC converter 11 and the second DCDC converter 12 to the smoothing capacitor 14.

When the first operation is completed at the time of pre-charge, the power control device 1 as a second operation, to boost the second DCDC converter 12. With auxiliary relay 15 by the first operation is turned off and the pre-charge relay 16 is turned on, when boosting the second DCDC converter 12, is boosted from the low voltage of the low voltage line 28 side to a high voltage, the auxiliary relay 15 side of the capacitor 17 at the same time to store the charge gradually flows a current to the smoothing capacitor 14 it is possible to store the charge. That is, the power control device 1 performs pre-charge of the smoothing capacitor 14 by boosting operation of the second DCDC converter 12 (pre-charge operation).

During pre-charge operation, the first DCDC converter 11 steps down the power from the high-voltage battery 2 to deliver it to the low-voltage line 28. The second DCDC converter 12 has a low voltage terminal as an input terminal, and functions as a step-up converter having a high voltage terminal as an output terminal. The second DCDC converter 12 is a low-voltage DC power supplied from the first DCDC converter 11 is boosted to a high voltage outputted from the high voltage end. The high voltage DC power outputted from the high voltage end of the second DCDC converter 12 is supplied to the smoothing capacitor 14 through the pre-charge relay 16. The power control device 1 increases the voltage of the capacitor 17 of the second DCDC converter 12 by the pre-charge operation and at the same time increases the voltage of the smoothing capacitor 14. The pre-charging is completed when the voltage of the smoothing capacitor 14 becomes equal to the voltage of the high-voltage battery 2.

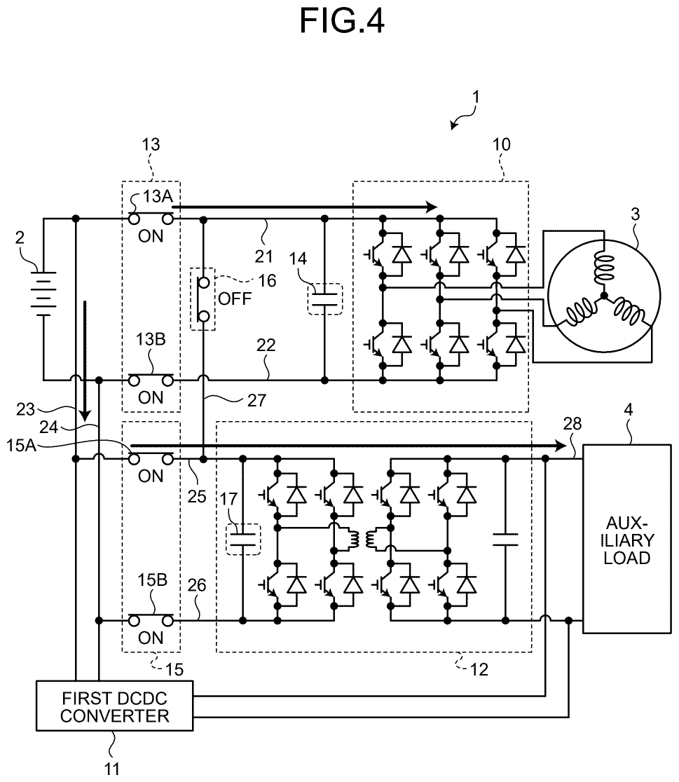

FIG. 4 is a diagram for explaining the time of travel of the electric vehicle. In a state in which the electric vehicle is running, the power control device 1 turns off the pre-charge relay 16. When the pre-charge of the smoothing capacitor 14 is completed and the electric vehicle shifts to the running state, the power control device 1 switches the pre-charge relay 16 from the on state to the off state as the first operation. After the pre-charge relay 16 is switched to the off state, the power control device 1 switches the first relay 13A, the third relay 15A, and the fourth relay 15B from the off state to the on state as the second operation. When this second operation is completed, the high-voltage battery 2 and the inverter 10 is connected via the SMR 13, the motor 3 is driven by the inverter 10. In addition, the high-voltage battery 2 and the second DCDC converter 12 are connected through the auxiliary relay 15, and the power from the high-voltage battery 2 is stepped down by the second DCDC converter 12 and supplied to the auxiliary equipment load 4.

As described above, according to the embodiment, it is possible to pre-charge the smoothing capacitor 14 at the same time as the pre-charge of the capacitor 17 of the second DCDC converter 12 with a simple structure. By turning on the second relay 13B and the pre-charge relay 16, in a state that can be cut off at the two poles of the first power line 21 and the second power line 22 of the high-voltage battery 2, pre-charge of the smoothing capacitor 14 and the pre-charge of the capacitor 17 of the auxiliary relay 15 of the second DCDC converter 12 can be done at the same time.

Further, since the high-voltage battery 2 and the first DCDC converter 11 is directly connected, it is possible to reduce the relay and the inrush preventing resistor between the high-voltage battery 2 and the first DCDC converter 11. Furthermore, since only one pre-charge relay 16 is provided, the number of relays can be reduced more than before. Thus, it is possible to reduce the size of the body.

Incidentally, when the power control unit (PCU) including the inverter 10 and the smoothing capacitor 14 is configured, the smoothing capacitor 14 can be expressed as a capacitor in the PCU. In this instance, the pre-charge relay 16 can be described as a relay provided between the second DCDC converter 12 and the PCU.

In the present disclosure, it is possible to pre-charge the capacitor while suppressing the size of the body.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power control device, mounted on an electric vehicle having no auxiliary battery, for supplying power of a high-voltage battery to a motor and an auxiliary load in the electric vehicle, comprising:
an inverter for converting the power from the high-voltage battery into AC power and outputting the AC power to the motor;
a first DCDC converter, having a high voltage end connected to the high-voltage battery without passing through any relays and a low voltage end connected to the auxiliary load, for stepping down the power from the high-voltage battery and outputting the stepped-down power to the auxiliary load;
a second DCDC converter, having a high voltage end connected to the high-voltage battery via relays and a low voltage end connected to the auxiliary, and connected in parallel with the to the first DCDC converter, and capable of bi-directional outputting to sides of the high voltage end and the low voltage end;
a first power line connecting a positive electrode terminal of the high-voltage battery and the inverter;
a second power line connecting a negative electrode terminal of the high-voltage battery and the inverter;
a system main relay including a first relay provided in the first power line, and a second relay provided in the second power line;
a smoothing capacitor, provided between the system main relay and the inverter, and connected to the first power line and the second power line;
an auxiliary relay including a third relay, provided between the positive electrode terminal of the high-voltage battery and the second DCDC converter, and a fourth relay, provided between the negative electrode terminal of the high-voltage battery and the second DCDC converter; and
a pre-charge relay, which is a fifth relay provided between a high-voltage end of the second DCDC converter and the smoothing capacitor.

2. The power control device according to claim 1, wherein
the second DCDC converter is an insulated-type DCDC converter, in which a capacitor is provided on a high-voltage end thereof, and
the fifth relay is provided between the capacitor of the second DCDC converter and the smoothing capacitor.

3. The power control device according to claim 2, further comprising:
a third power line connecting the first power line and the first DCDC converter;
a fourth power line connecting the second power line and the first DCDC converter;
a fifth power line connecting the third power line and the second DCDC converter;
a sixth power line connecting the fourth power line and the second DCDC converter; and
a seventh power line connecting the fifth power line and the first power line, wherein
the third relay is provided on the fifth power line,
the fourth relay is provided on the sixth power line,
the fifth relay is provided on the seventh power line,
the third power line has one end, which is connected to a portion between the positive electrode terminal of the high-voltage battery and the first relay in the first power line, and another end, which is connected to the high-voltage end of the first DCDC converter,
the fourth power line has one end, which is connected to a portion between the negative electrode terminal of the high-voltage battery and the second relay in the second power line, and another end, which is connected to the high-voltage end of the first DCDC converter,
the fifth power line has one end, which is connected to the third power line, and another end, which is connected to the high-voltage end of the second DCDC converter,
the sixth power line has one end, which is connected to the fourth power line, and another end, which is connected to the high-voltage end of the second DCDC converter, and
the seventh power line has one end, which is connected to a portion between the first relay and the smoothing capacitor in the first power line, and another end, which is connected to a portion between the third relay and the second DCDC converter in the fifth power line.

4. The power control device according to claim 1, wherein
in a case where the power from the high-voltage battery is pre-charged to the smoothing capacitor, the second relay and the fifth relay are turned on, and the first relay, the third relay, and the fourth relay are turned off.
